(19) United States
(12) Patent Application Publication
(10) Pub. No.: US 2003/0037327 A1
(43) Pub. Date: Feb. 20, 2003

(54) Run-time rule-based topological installation suite

(75) Inventors: Ulises J. Cicciarelli, Miami, FL (US); James E. Fox, Apex, NC (US); Francisco Gonzalez, Apex, NC (US); Robert C. Leah, Cary, NC (US)

Correspondence Address: IBM Corporation T81/062, PO Box 12195, Research Triangle Park, NC, 27709, US

(73) Assignee: International Business Machines Corporation, Armonk, NY

(21) Appl. No.: 09/930,325

(22) Filed: Aug. 15, 2001

(51) Int. Cl. G06F 9/445; G06F 9/44

(52) U.S. Cl. 717/178; 717/170

(57) ABSTRACT

Methods, systems, and computer program products for improving installation of software suites by automatically and dynamically obtaining information pertaining to the heterogeneous run-time environment in which the suite will be installed, and using this information as input to a rules engine which evaluates rules to dynamically select a predetermined topology-specific configuration of the suite. The software installation process is thereby adapted and configured dynamically based on the unique topology of the environment in which the suite is being installed, yet the burden on the software installer to understand the intricacies of his run-time environment (and to reflect those details in the suite customization process) is greatly reduced. Software installation is therefore quicker, easier, and less error-prone than in prior art approaches.

### Related Inventions

The present invention is related to U.S. Pat. No. ______ (Ser. No. 09/669,227, filed Sep. 25, 2000), titled “Object Model and Framework for Installation of Software Packages Using JavaBeans™; U.S. Pat. No. ______ (Ser. No. 09/707,656, filed Nov. 7, 2000), titled “Object Model and Framework for Installation of Software Packages Using Object Descriptors”; U.S. Pat. No. ______ (Ser. No. 09/707,545, filed Nov. 7, 2000), titled “Object Model and Framework for Installation of Software Packages Using Object REXX”; U.S. Pat. No. ______ (Ser. No. 09/707,700, filed Nov. 7, 2000), titled “Object Model and Framework for Installation of Software Packages Using Structured Documents”; U.S. Pat. No. ______ (Ser. No. 09/879,694, filed Jun. 12, 2001), titled “Efficient Installation of Software Packages”; U.S. Pat. No. ______ (Ser. No. 09/______ , filed Jul. 19, 2001), titled “Object Model and Framework for Installation of Software Packages using a Distributed Directory”; and U.S. Pat. No. ______ (Ser. No. 09/______, filed concurrently herewith), titled “Extending Installation Suites to Include Topology of Suite's Run-Time Environment”. These inventions are commonly assigned to the International Business Machines Corporation (“IBM”) and are hereby incorporated herein by reference.

### BACKGROUND OF THE INVENTION

1. Field of the Invention

The present invention relates to a computer system, and deals more particularly with methods, systems, and computer program products for improving the installation of software packages or “suites” by using rules and a rules engine to dynamically determine the topology of the run-time environment into which the suite will be installed, in order to automatically select a suite configuration which is adapted to that topology.

2. Description of the Related Art

Use of computers in today's society has become pervasive. The software applications to be deployed, and the computing environments in which they will operate, range from very simple to extremely large and complex. The computer skills base of those responsible for installing the software applications ranges from novice or first-time users, who may simply want to install a game or similar application on a personal computer, to experienced, highly-skilled system administrators with responsibility for large, complex computing environments. The process of creating a software installation package that is properly adapted to the skills of the eventual installer, as well as to the target hardware and software computing environment, and also the process of performing the installation, can therefore be problematic.

In recent decades, when the range of computing environments and the range of user skills was more constant, it was easier to target information on how software should be installed. Typically, installation manuals were written and distributed with the software. These manuals provided textual information on how to perform the installation of a particular software application. These manuals often had many pages of technical information, and were therefore difficult to use by those not having considerable technical skills. “User-friendliness” was often overlooked, with the description of the installation procedures focused solely on the technical information needed by the software and system.

With the increasing popularity of personal computers came a trend toward easier, more user-friendly software installation, as software vendors recognized that it was no longer reasonable to assume that a person with a high degree of technical skill would be performing every installation process. However, a number of problem areas remained because of the lack of a standard, consistent approach to software installation across product and vendor boundaries. These problems, which are addressed in the related inventions, will now be described.

The manner in which software packages are installed today, and the formats of the installation images, often varies widely depending on the target platform (i.e. the target hardware, operating system, etc.), the installation tool in use, and the underlying programming language of the software to be installed, as well as the natural language in which instructions are provided and in which input is expected. When differences of these types exist, the installation process often becomes more difficult, leading to confusion and frustration for users. For complex software packages to be installed in large computing systems, these problems are exacerbated. In addition, developing software installation packages that attempt to meet the needs of many varied target environments (and the skills of many different installers) requires a substantial amount of time and effort.

One area where consistency in the software installation process is advantageous is in knowing how to invoke the installation procedure. Advances in this area have been made in recent years, such that today, many software packages use some sort of automated, self-installing procedure. For example, a file (which, by convention, is typically named “setup.exe” or “install.exe”) is often provided on an installation medium (such as a diskette or CD-ROM). When the installer issues a command to execute this file, an installation program begins. Issuance of the command may even be automated in some cases, whereby simply inserting the installation medium into a mechanism such as a CD-ROM reader automatically launches the installation program.

These automated techniques are quite beneficial in enabling the installer to get started with an installation. However, there are a number of other factors which may result in a complex installation process, especially for large-scale applications that are to be deployed in enterprise computing environments. For example, there may be a number of parameters that require input during installation of a particular software package. Arriving at the proper values to use for these parameters may be quite complicated, and the parameters may even vary from one target machine to another. There may also be a number of prerequisites and/or co-requisites, including both software and hardware specifications, that must be accounted for in the installation process. There may also be issues of version control to be addressed when software is being upgraded. An entire suite or package of software applications may be designed for simultaneous installation, leading to even more complications. In addition, installation procedures may vary widely from one installation experience to another, and the procedure used for complex enterprise software application packages may be quite different from those used for consumer-oriented applications.

Furthermore, these factors also affect the installation package developers, who must create installation packages which properly account for all of these variables. Today, installation packages are typically created using vendor-specific and product-specific installation software. Adding to or modifying an installation package can be quite complicated, as it requires determining which areas of the installation source code must be changed, correctly making the appropriate changes, and then recompiling and retesting the installation code. End-users may be prevented from adding to or modifying the installation packages in some cases, limiting the adaptability of the installation process. The lack of a standard, robust product installation interface therefore results in a labor-intensive and error-prone installation package development procedure.

Other practitioners in the art have recognized the need for improved software installation techniques. In one approach, generalized object descriptors have been adapted for this purpose. An example is the Common Information Model (CIM) standard promulgated by The Open Group™ and the Desktop Management Task Force (DTMF). The CIM standard uses object descriptors to define system resources for purposes of managing systems and networks according to an object-oriented paradigm. However, the object descriptors which are provided in this standard are very limited, and do not suffice to drive a complete installation process. In another approach, system management functions such as Tivoli® Software Distribution, Computer Associates Unicenter TNG®, Intel LANDesk® Management Suite, and Novell ZENWorks™ for Desktops have been used to provide a means for describing various packages for installation. Unfortunately, these descriptions lack cross-platform consistency, and are dependent on the specific installation tool and/or system management tool being used. In addition, the descriptions are not typically or consistently encapsulated with the install image, leading to problems in delivering bundle descriptions along with the corresponding software bundle, and to problems when it is necessary to update both the bundle and the description in a synchronized way. (The CIM standard is described in “Systems Management: Common Information Model (CIM)”, Open Group Technical Standard, C804 ISBN 1-85912-255-8, August 1998. “Tivoli” is a registered trademark of Tivoli Systems Inc. “Unicenter TNG” is a registered trademark of Computer Associates International, Inc. “LANDesk” is a registered trademark of Intel Corporation. “ZENWorks” is a trademark of Novell, Inc.)

The related inventions teach use of an object model and framework for software installation packages and address many of these problems of the prior art, enabling the installation process to be simplified for software installers as well as for the software developers who must prepare their software for an efficient, trouble-free installation, and define several techniques for improving installation of software packages. While the techniques disclosed in the related inventions provide a number of advantages and are functionally sufficient, there may some situations in which the techniques disclosed therein may be improved upon.

In particular, while practitioners of the art have long bundled or grouped individual software products together into a common set of installable and configurable entities to create installation suites, a prior art installation suite only encompasses the individual products and their configurable data. For example, a suite may contain a number of IBM middleware products which are to be deployed across an enterprise, such as IBM WebSphere® Application Server, IBM HTTP Server, Lotus® Domino™, DB2 Universal Database™, and associated clients. In prior art approaches, installation suites wire these products and their configuration data together to enable the suite to deliver a fixed, static solution to a customer. (“WebSphere” is a registered trademark, and “DB2 Universal Database” is a trademark, of IBM. “Lotus” is a registered trademark, and “Domino” is a trademark, of Lotus Development Corporation.)

One prior art approach which deploys static solutions is the BackOffice product from Microsoft Corporation. Using BackOffice, a bundle of software and configuration data is provided, but the bundle comprises static information. Static solutions may, in some cases, provide a less-than-optimal approach to suite installation.

### SUMMARY OF THE INVENTION

An object of the present invention is to provide an improved technique for installation of software packages.

It is another object of the present invention to provide this technique using a model and framework that provides for a consistent and efficient installation across a wide variety of target installation environments, where installation suites created according to that model and framework are automatically adapted to account for the dynamic run-time environment of a heterogeneous target environment.

Another object of the present invention is to provide a software installation technique that enables installation suites to be more flexible and efficient than prior art static installation suites, by dynamically obtaining the topology of the target run-time environment and using this topology information as input to a rules engine for purposes of automatically selecting a particular configuration of an installation suite.

Still another object of the present invention is to provide an improved software installation technique wherein an installer is not required to manually select the configuration of products within an installation suite which is most appropriate for the topology of his run-time environment.

Yet another object of the present invention is to provide software installation suites which are automatically and dynamically adapted for a particular target topology.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for improving installation of software packages using dynamically-obtained topology information. This technique comprises: defining an object model representing a plurality of components of a software installation package and one or more topology objects, wherein each component comprises a plurality of objects and wherein each topology object identifies one or more selected ones of the components; populating the object model to describe a particular software installation package and one or more topologies for deployment of that particular software installation package; and defining one or more rules for execution by a rules engine, wherein each rule specifies one or more conditions and at least one action to be taken when the specified conditions are matched during the execution by the rules engine, and wherein the specified conditions pertain to a target run-time environment and the at least one action may be used to select from among the topologies.

The technique may further comprise instantiating a plurality of objects according to the defined object model, wherein the populating process populates the instantiated objects. The instantiating may further comprise instantiating an object for the particular software installation package and one or more component objects for each software component included in the particular software installation package.

The technique preferably further comprises: dynamically discovering information pertaining to the target run-time environment; using the dynamically discovered information as input to the execution by the rules engine, wherein the execution results in matching a selected one of the rules; automatically selecting, based upon the at least one action in the matching rule, at least one of the topologies for deployment; and using the populated object model to install the particular software installation package using the selected topology.

Using the populated object model may further comprise: identifying one or more target machines on which the particular software installation package is to be installed; downloading the particular software installation package to the identified target machines; and performing an installation at each of the identified target machines using the downloaded particular software installation package. The technique may also further comprise authenticating a server on which the downloading process operates prior to performing the installation.

Optionally, using the dynamically discovered information as input to the execution by the rules engine may also serve to configure one or more values needed by the selected topology. The instantiated objects may be JavaBeans.

The present invention will now be described with reference to the following drawings, in which like reference numbers denote the same element throughout.

### BRIEF DESCRIPTION OF THE DRAWINGS

FIG. 1 is a block diagram of a computer hardware environment in which the present invention may be practiced;

FIG. 2 is a diagram of a networked computing environment in which the present invention may be practiced;

FIG. 3 illustrates sample rules that may be processed by a rules engine to dynamically select an appropriate configuration of a software installation suite, according to the present invention;

FIG. 4 shows a sample graphical user interface (“GUI”) that may be presented to a software installer during a software installation process when using the present invention;

FIG. 5 illustrates an object model that may be used for defining software components to be included in an installation suite, according to the related inventions;

FIG. 6 depicts an object model that may be used for defining a suite, or package, of software components to be installed, according to the related inventions, enabling installation improvements according to the present invention;

FIGS. 7 and 8 depict resource bundles that may be used for specifying various types of product and variable information to be used during an installation, according to an embodiment of the related inventions; and

FIGS. 9-12 depict flowcharts illustrating logic with which a software installation suite may be processed, according to preferred embodiments of the present invention.

### DESCRIPTION OF PREFERRED EMBODIMENTS

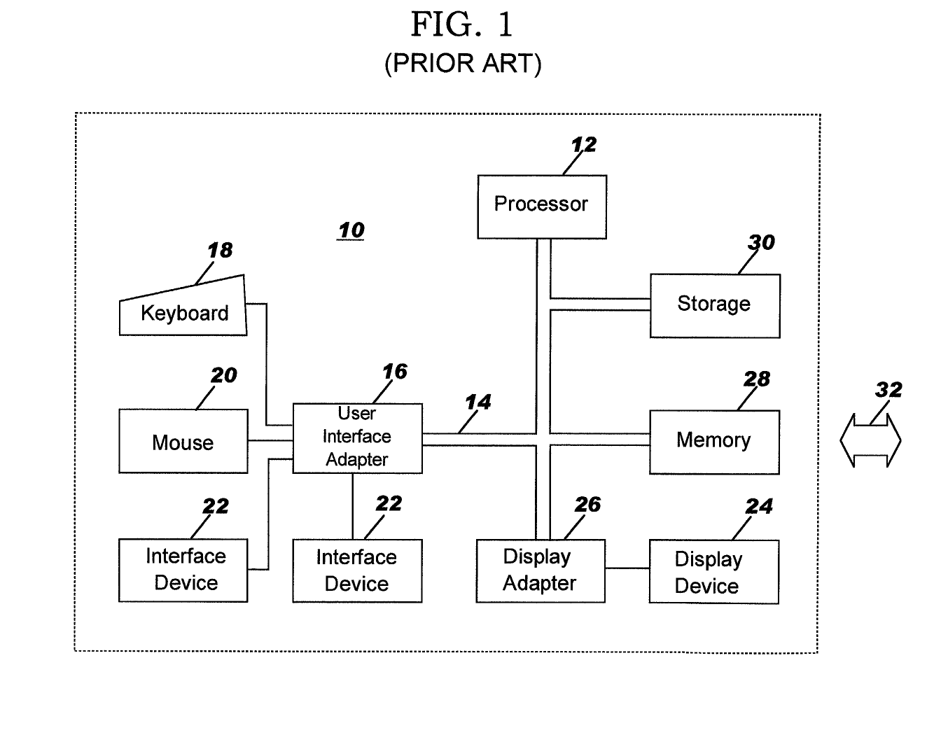

FIG. 1 illustrates a representative computer hardware environment in which the present invention may be practiced. The device 10 illustrated therein may be a personal computer, a laptop computer, a server or mainframe, and so forth. The device 10 typically includes a microprocessor 12 and a bus 14 employed to connect and enable communication between the microprocessor 12 and the components of the device 10 in accordance with known techniques. The device 10 typically includes a user interface adapter 16, which connects the microprocessor 12 via the bus 14 to one or more interface devices, such as a keyboard 18, mouse 20, and/or other interface devices 22 (such as a touch sensitive screen, digitized entry pad, etc.). The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The device 10 may communicate with other computers or networks of computers, for example via a communications channel or modem 32. Alternatively, the device 10 may communicate using a wireless interface at 32, such as a CDPD (cellular digital packet data) card. The device 10 may be associated with such other computers in a local area network (LAN) or a wide area network (WAN), or the device 10 can be a client in a client/server arrangement with another computer, etc. All of these configurations, as well as the appropriate communications hardware and software which enable their use, are known in the art.

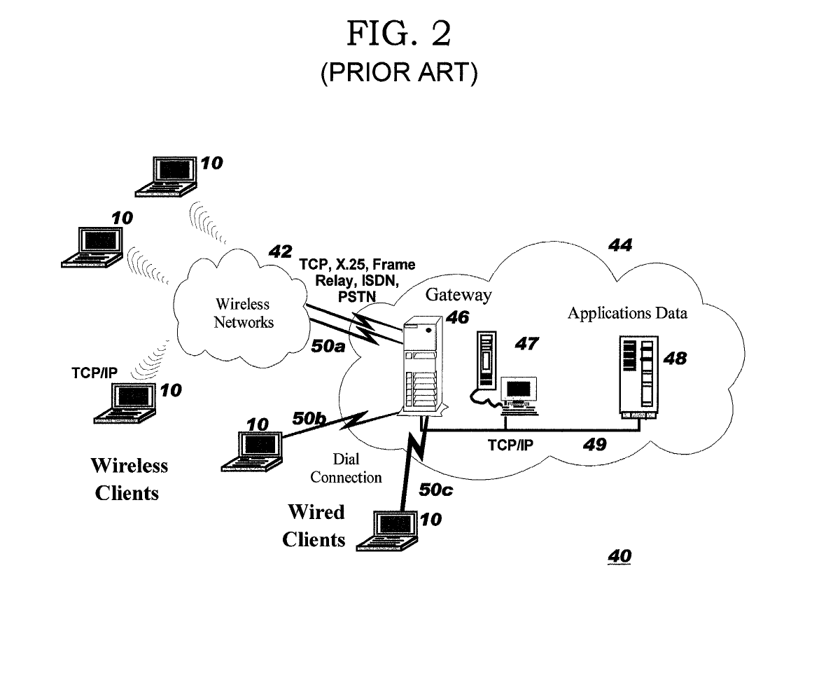

FIG. 2 illustrates a data processing network 40 in which the present invention may be practiced. The data processing network 40 may include a plurality of individual networks, such as wireless network 42 and network 44, each of which may include a plurality of devices 10. Additionally, as those skilled in the art will appreciate, one or more LANs may be included (not shown), where a LAN may comprise a plurality of intelligent workstations or similar devices coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be coupled to another network 42 by means of a communications link 50a. The gateway 46 may also be directly coupled to one or more devices 10 using a communications link 50b, 50c. Further, the gateway 46 may be indirectly coupled to one or more devices 10. The gateway computer 46 may also be coupled 49 to a storage device (such as data repository 48). The gateway computer 46 may be implemented utilizing an Enterprise Systems Architecture/370™ computer available from IBM, an Enterprise Systems Architecture/390® computer, etc. Depending on the application, a midrange computer, such as an Application System/400® (also known as an AS/400®) may be employed. (“Enterprise Systems Architecture/370” is a trademark of IBM; “Enterprise Systems Architecture/390”, “Application System/400”, and “AS/400” are registered trademarks of IBM.)

Those skilled in the art will appreciate that the gateway computer 46 may be located a great geographic distance from the network 42, and similarly, the devices 10 may be located a substantial distance from the networks 42 and 44. For example, the network 42 may be located in California, while the gateway 46 may be located in Texas, and one or more of the devices 10 may be located in New York. The devices 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or UDP (User Datagram Protocol) over IP, X.25, Frame Relay, ISDN (Integrated Services Digital Network), PSTN (Public Switched Telephone Network), etc. The devices 10 may alternatively connect directly to the gateway 46 using dial connections 50b or 50c. Further, the wireless network 42 and network 44 may connect to one or more other networks (not shown), in an analogous manner to that depicted in FIG. 2.

In preferred embodiments, the present invention is implemented in software. Software programming code which embodies the present invention is typically accessed by the microprocessor 12 (e.g. of device 10 and/or server 47) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

A user of the present invention (e.g. a software installer or a software developer creating a software installation package or suite) may connect his computer to a server using a wireline connection, or a wireless connection. (Alternatively, the present invention may be used in a stand-alone mode without having a network connection.) Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing capabilities (and communication capabilities when the device is network-connected). The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

When implemented in software, the present invention may be implemented as one or more computer software programs. The software is preferably implemented using an object-oriented programming language, such as the Java™ programming language. The model which is used for describing the aspects of software installation packages is preferably designed using object-oriented modeling techniques of an object-oriented paradigm. In preferred embodiments, the objects which are based on this model, and which are created to describe the installation aspects of a particular installation package, may be specified using a number of approaches, including but not limited to: JavaBeans™ or objects having similar characteristics; structured markup language documents (such as Extensible Markup Language, or “XML”, documents); object descriptors of an object modeling notation; or Object REXX or objects in an object scripting language having similar characteristics. (“Java” and “JavaBeans” are trademarks of Sun Microsystems, Inc.) For purposes of illustration and not of limitation, the following description of preferred embodiments refers to objects which are JavaBeans.

An implementation of the present invention may be executing in a Web environment, where software installation packages are downloaded using a protocol such as the HyperText Transfer Protocol (“HTTP”) from a Web server to one or more target computers which are connected through the Internet. Alternatively, an implementation of the present invention may be executing in other non-Web networking environments (using the Internet, a corporate intranet or extranet, or any other network) where software packages are distributed for installation using techniques such as Remote Method Invocation (“RMI”) or Common Object Request Broker Architecture (“CORBA”). Configurations for the environment include a client/server network, as well as a multi-tier environment. Or, as stated above, the present invention may be used in a stand-alone environment, such as by an installer who wishes to install a software package from a locally-available installation media rather than across a network connection. Furthermore, it may happen that the client and server of a particular installation both reside in the same physical device, in which case a network connection is not required. A software developer who prepares a software package for installation using the present invention may use a network-connected workstation, a stand-alone workstation, or any other similar computing device. These environments and configurations are well known in the art.

The target devices with which the present invention may be used advantageously include end-user workstations, mainframes or servers on which software is to be loaded, or any other type of device having computing or processing capabilities (including “smart” appliances in the home, cellular phones, personal digital assistants or “PDAs”, dashboard devices in vehicles, etc.).

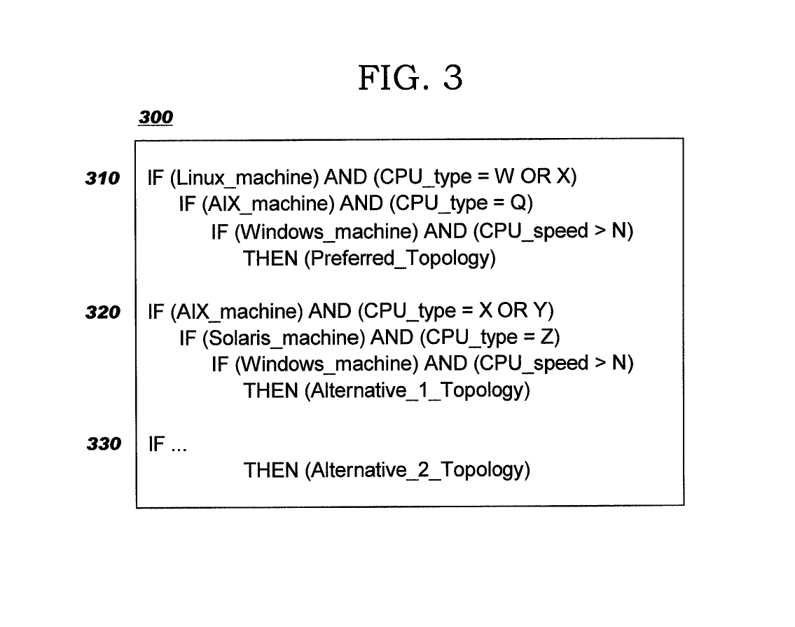

Preferred embodiments of the present invention will now be discussed in more detail with reference to FIGS. 3 through 12.

The present invention uses an object model for software package installation, in which a framework is defined for creating one or more objects which comprise each software installation package or suite. (The terms “software installation package” and “installation suite” are used synonymously herein.) The basis for this object model is disclosed in the related inventions, and various ones of the related inventions disclose variations to that object model. The present invention discloses a technique for using an extension to the object model which includes topology information that enables the preparer of the installation suite to specify one or more topology-specific configurations for the component products included in the suite, and then dynamically obtaining information describing a target run-time environment into which components of the suite are to be installed. The obtained information is used as input to a rules engine, which compares it to predefined rules describing how to select from among the defined topology-specific configurations of the suite. These techniques will be described in more detail herein.

While preferred embodiments of the software object model and framework are described in the related inventions, extensions to the model are described herein within the context of the overall model. As disclosed in the related inventions, each installation object preferably comprises object attributes and methods for the following:

1) A manifest, or list, of the files comprising the software package to be installed.

2) Information on how to access the files comprising the software package. This may involve:

a) explicit encapsulation of the files within the object, or

b) links that direct the installation process to the location of the files (which may optionally include a specification of any required access protocol, and of any compression or unwrapping techniques which must be used to access the files).

3) Default response values to be used as input for automatically responding to queries during customized installs, where the default values are preferably specified in a response file. The response file may specify information such as how the software package is to be subset when it is installed, where on the target computer it is to be installed, and other values to customize the behavior of the installation process.

4) Methods, usable by a systems administrator or other software installation personnel, for setting various response values or for altering various ones of the default response values to tailor a customized install.

5) Validation methods to ensure the correctness and internal consistency of a customization and/or of the response values otherwise provided during an installation.

6) Optionally, localizable strings (i.e. textual string values that may be translated, if desired, in order to present information to the installer in his preferred natural language).

7) Instructions (referred to herein as the “command line model”) on how the installation program is to be invoked, and preferably, how return code information or other information related to the success or failure of the installation process may be obtained.

8) The capabilities of the software package (e.g. the functions it provides).

9) A specification of the dependencies, including prerequisite or co-requisites, of the software package (such as the required operating system, including a particular level thereof; other software functions that must be present if this package is to be installed; software functions that cannot be present if this package is installed; etc.).

The present invention uses the topology extensions to this model which were disclosed in the related invention titled “Extending Installation Suites to Include Topology of Suite's Run-Time Environment” (referred to herein as “the topology suite invention”), along with rules that are adapted to dynamically selecting from among the topology-specific configurations of a suite (where those configurations have been specified during suite creation). In this manner, the dynamically-determined topology of a heterogeneous run-time environment may be used to automatically select a configuration of the installation suite that is adapted for that particular target environment, such that the installation suite is not limited to the static software and its configuration data which are included in prior art installation suites. Suppose, for example, that it is desirable to deploy a business-to-business solution throughout an enterprise by installation of a suite, where this solution includes the middleware products previously discussed (that is, IBM WebSphere Application Server, IBM HTTP Server, DB2 database software, and run-time clients for these products). An installation suite according to the topology suite invention, which may also be referred to as a “topological suite”, may then be created for this deployment. In particular, a topology suite using this example may specify: (1) a predetermined optimal topology of networked machines (that is, specific types of servers and/or clients to which the software products should be installed); (2) a set of software that, when combined, provides a customer solution; and (3) the specific wiring of the software configuration and network topology which assists in the deployment of the solution. The present invention adds a set of rules for this topological suite, where this set of rules may be used by a rules engine to determine a preference for installing the software components on particular types of devices.

Continuing with the example, perhaps the installation suite contains software to install one or more of the following actual components: (1) WebSphere on AIX® servers and/or WebSphere on Linux® servers; (2) DB2® on AIX, Linux, and/or Sun Solaris™ machines; and (3) run-time clients for the above products on Windows® and/or Linux machines. (“Linux” is a registered trademark of Linus Torvalds. “AIX” and “DB2” are registered trademarks of IBM. “Windows” is a registered trademark of Microsoft Corporation. “Solaris” is a trademark of Sun Microsystems, Inc.) Suppose further that the software developer (or other person who creates the installation suite) has information suggesting that an optimal configuration for the deployment of these components is to install the WebSphere code on one or more Linux servers, if available; the DB2 database server software on one or more AIX servers, if available; and the clients onto computers having a Windows operating system. The developer may have also determined that, if the devices for this optimal configuration are not available, then a next-best choice is to install the WebSphere code on one or more AIX servers, the DB2 database server software on Solaris servers, and the clients on Windows devices. Additional alternative configurations might also be determined, if appropriate, for each next-best choice down to and including the minimum required configuration. The developer (or other person) generates rules for processing by a rules engine, where the rules engine will select from among the configurations defined in the topological suite by matching input values against one or more conditions or predicates in the rules.

FIG. 3 illustrates several rules 310, 320, 330 which comprise a sample rules base 300 to illustrate selection of a topology-specific configuration based upon dynamically-obtained topology input information. Rule 310, for example, is intended to illustrate the preferred configuration where information about the central processing unit (“CPU”) of a target machine is also considered when matching the conditions in the rules. Rule 310 checks for availability of an AIX machine having a particular type of CPU (shown as having the value “X” or “Y” in the example syntax), and of an AIX machine having a different type of CPU (having the value “Q” in the example syntax), and of a Windows machine having a CPU speed that exceeds some number “N”. When all of these conditions are met by the input topology information, a value of “Preferred_Topology” will be returned as output of matching this rule 310. Rules 320 and 330 specify different conditions, and if these conditions are matched when the rules engine executes, then a value of “Alternative_1_Topology” or “Alternative_2_Topology”, respectively, will be returned. (It will be obvious that the syntax shown in FIG. 3 is merely illustrative of syntax that may be used for specifying rules.)

Using the techniques disclosed in the topology suite invention, an installation suite may be specially adapted for one or more predetermined configurations (i.e. target topologies), as disclosed therein. By associating each predetermined configuration with a name or identifier that matches the action or result part of a rule in the rules base, firing the rules will automatically identify the predetermined topology-specific configuration that will be selected for installation, according to the present invention. (Refer to the following discussions of instances of Topology class 680 for more information about the predetermined topology-specific configurations.)

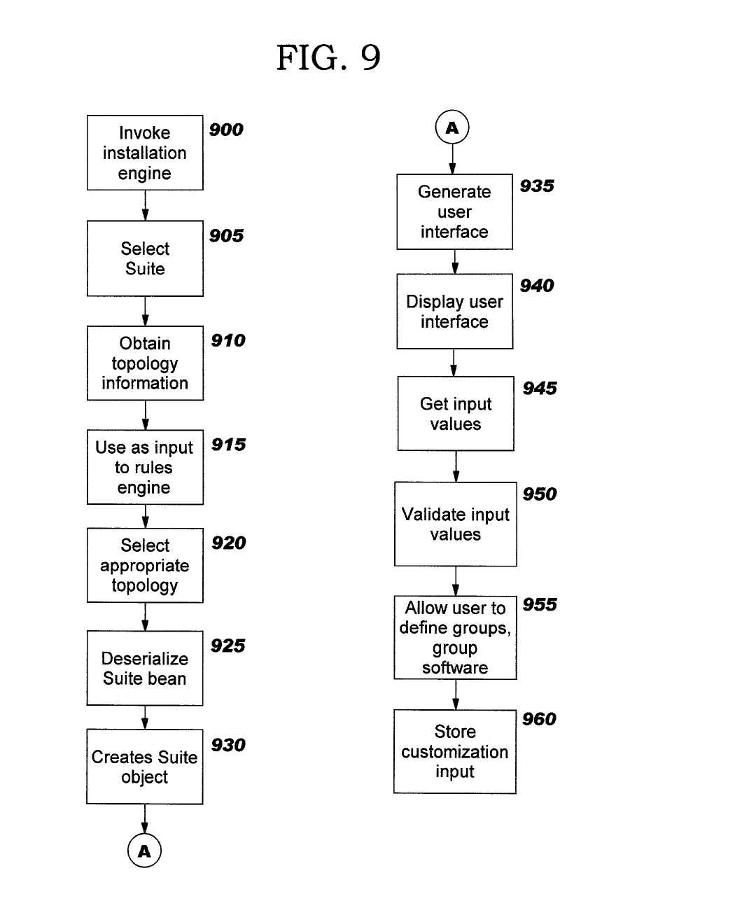

The details of the run-time environment may be discovered automatically and dynamically using inventory discovery techniques which are known in the art. Typically, such discovery techniques contact an inventory agent, which is a process executing on a device for the purpose of reporting information, upon request, about the device's capabilities and its installed hardware and software features. According to preferred embodiments of the present invention, the discovery process is executed when the software installer invokes the suite installation process (as described in more detail below with reference to FIG. 9), although alternatively this information may be obtained in advance and stored for use when the suite installation commences.

As will be obvious, the information that may be obtained from the dynamic discovery process may vary widely, and is not limited to the information which is described herein for purposes of illustration. Similarly, the rules used with the present invention are not limited to specifying the types of information which is used in the examples herein. As one example of information that may be used in rules of the rules base, specific configuration data such as the optimal port to be used by a software component can be described by rules. As another example, the operating system(s) installed in the run-time environment may also be used in the rule predicates to influence the selection of a configuration. Many other examples may be envisaged, and the factors that are relevant to the rules in a particular implementation of the present invention may vary widely depending upon (among other things) the software components which make up the installation suite.

Use of the present invention has a number of advantages over the prior art. First, the actual deployment of a solution occurs more quickly and efficiently when using rules and a rules engine, and is automatically and dynamically based upon the customer's actual environment. In addition to this increased speed and efficiency, the solution that is deployed is an optimal solution for the target environment, based on the conditions expressed in the rules and the values that are matched against those conditions. Furthermore, the individual who deploys the solution no longer needs in-depth knowledge or understanding of the software solution embodied in the installation suite and the interrelationships among the components of the suite, since the rules contain information enabling an automated selection of the optimal configuration for each particular run-time environment. This, in turn, should lead to fewer problems and errors during the installation process and an overall reduction in cost as well as time.

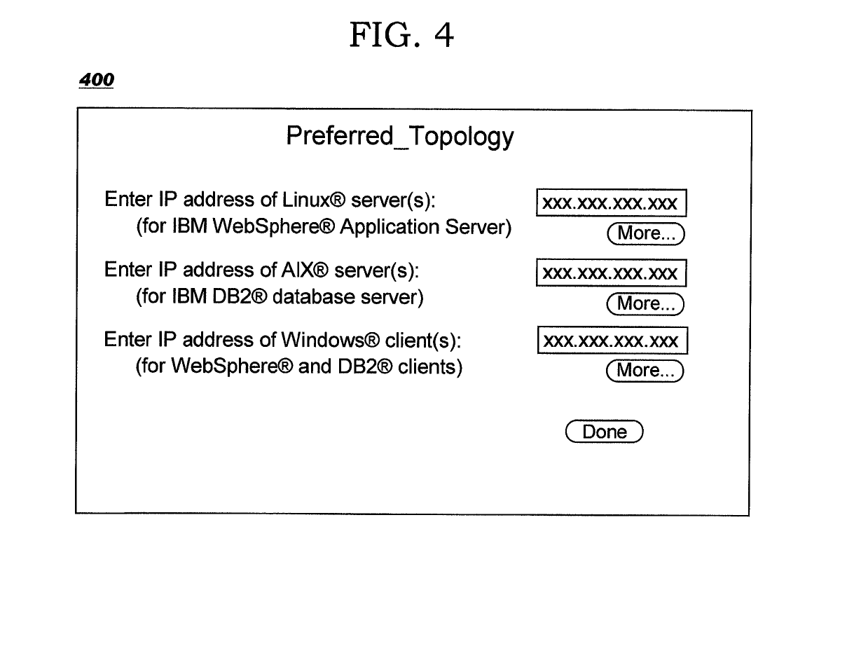

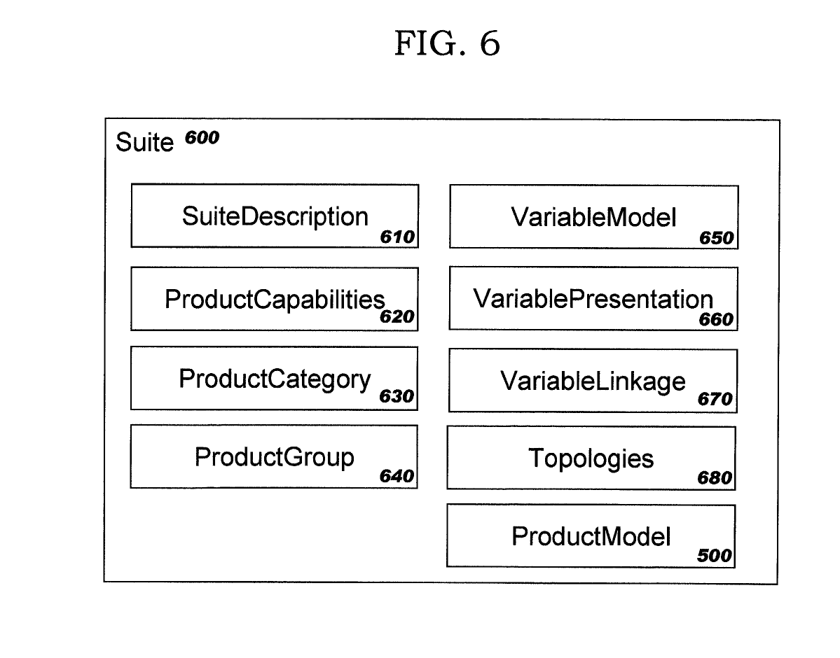

With the example deployment scenario and the sample optimal configuration thereof, the preferred topology may be identified (for example) with a name such as —Preferred_Topology”, as shown in the action part of rule 310. This preferred topology may be reflected in the installation suite by specifying a server group pertaining to the Linux computers, another server group pertaining to the AIX computers, and a client group pertaining to the Windows computers. (Use of groups within a suite is discussed in more detail below, with reference to FIGS. 6 and 9.) The other example topologies may be reflected in an analogous manner by specifying an “Alternative_1_Topology” and an “Alternative_2_Topology”. As stated earlier, many details of the target run-time environment may be discovered automatically and may be used to dynamically configure the installation suite. In some cases, it may be necessary or desirable to allow the installer to manually provide certain additional configuration values, depending on the installation suite (or perhaps to override selected configuration values). In this case, a predefined template may be provided with the installation suite and presented to the installer at installation time to enable the installer to specify input values. An example template 400 is shown in FIG. 4. As illustrated therein, the software installer is allowed to enter one or more IP addresses for each group of machines in this topology. Preferably, this information is supplied during the suite customization process. (Refer to the discussion of FIG. 9, below, for more information on suite customization.) One or more such templates may be provided with a particular installation suite, depending on the content of the suite, how it is best installed in an enterprise, the wishes of the suite creator, and so forth. When multiple templates are provided with a suite, a GUI window (not shown) may be presented to the installer to display the available templates and to allow the installer to select one that suits his needs. (With reference to the example deployment scenario, different templates might be supplied for the alternative topologies reflected in rules 320 and 330.)

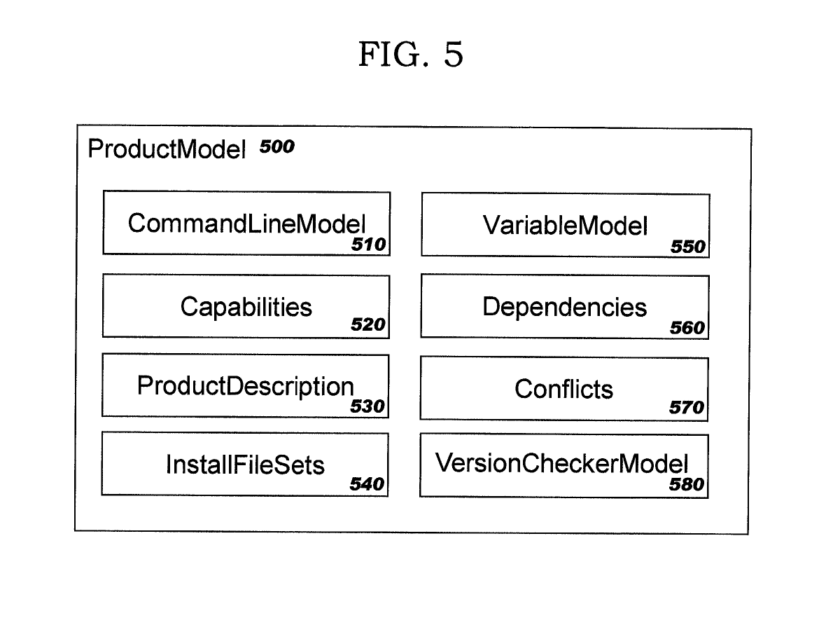

A preferred embodiment of the object model used for defining installation packages as disclosed in the related inventions, and enhancements thereto which may be made for the topological suites of the topology suite invention, is depicted in FIGS. 5 and 6. FIG. 5 illustrates a preferred object model to be used for describing each software component present in an installation package for a topological suite. A graphical containment relationship is illustrated, in which (for example) ProductModel 500 is preferably a parent of one or more instances of CommandLineModel 510, Capabilities 520, etc. FIG. 6 illustrates a preferred object model that may be used for describing a topological suite comprising all the components present in a particular installation package. (It should be noted, however, that the model depicted in FIGS. 5 and 6 is merely illustrative of one structure that may be used to represent installation packages according to the present invention. Other subclasses may be used alternatively, and the hierarchical relationships among the subclasses may be altered, without deviating from the inventive concepts disclosed herein.) A version of the object model depicted by FIGS. 5 and 6 has been described in detail in the related inventions. This description is presented here as well in order to establish a context for the present invention. The manner in which the present invention uses the topological suites of the topology suite invention, along with dynamic discovery of the target run-time environment and rules from a rules base, is described herein in context of the overall model.

Note that each of the related inventions may differ slightly in the terms used to describe the object model and the manner in which it is processed. For example, the related invention pertaining to use of structured documents refers to elements and subelements, and storing information in document form, whereas the related invention pertaining to use of JavaBeans refers to classes and subclasses, and storing information in resource bundles. As another example, the related inventions disclose several alternative techniques for specifying information for installation objects, including: use of resource bundles when using JavaBeans; use of structured documents encoded in a notation such as the Managed Object Format (“MOF”) or XML; and use of properties sheets. These differences will be well understood by one of skill in the art. For ease of reference when describing the present invention, the discussion herein is aligned with the terminology used in the JavaBeans-based disclosure; it will be obvious to those of skill in the art how this description may be adapted in terms of the other related inventions.

A ProductModel 500 object class is defined, according to the related inventions, which serves as a container for all information relevant to the installation of a particular software component. The contained information is shown generally at 510 through 580, and comprises the information for a particular component installation, as will now be described in more detail.

A CommandLineModel class 510 is used for specifying information about how to invoke an installation (i.e. the “command line” information, which includes the command name and any arguments). In preferred embodiments of the object model disclosed in the related inventions, CommandLineModel is an abstract class, and has subclasses for particular types of installation environments. These subclasses preferably understand, inter alia, how to install certain installation utilities or tools. For example, if an installation tool “ABC” is to be supported for a particular installation package, an ABCCommandLine subclass may be defined. Instances of this class then provide information specific to the needs of the ABC tool. A variety of installation tools may be supported for each installation package by defining and populating multiple such classes. Preferably, instances of these classes reference a resource or resource bundle which specifies the syntax of the command line invocation. (Alternatively, the information may be stored directly in the instance.)

Instances of the CommandLineModel class 510 preferably also specify the response file information (or a reference thereto), enabling automated access to default response values during the installation process. In addition, these instances preferably specify how to obtain information about the success or failure of an installation process. This information may comprise identification of particular success and/or failure return codes, or the location (e.g. name and path) of a log file where messages are logged during an installation. In the latter case, one or more textual strings or other values which are designed to be written into the log file to signify whether the installation succeeded or failed are preferably specified as well. These string or other values can then be compared to the actual log file contents to determine whether a successful installation has occurred. For example, when an installation package is designed to install a number of software components in succession, it may be necessary to terminate the installation if a failure is encountered for any particular component. The installation engine of the present invention may therefore automatically determine whether each component successfully installed before proceeding to the next component.

Additional information may be specified in instances of CommandLineModel, such as timer-related information to be used for monitoring the installation process. In particular, a timeout value may be deemed useful for determining when the installation process should be considered as having timed out, and should therefore be terminated. One or more timer values may also be specified that will be used to determine such things as when to check log files for success or failure of particular interim steps in the installation.

Instances of a Capabilities class 520 are used to specify the capabilities or functions a software component provides. Capabilities thus defined may be used to help the installer select among components provided in an installation package, and/or may be used to programmatically enforce install-time checking of variable dependencies. As an example of the former, suppose an installation package includes a number of printer driver software modules. The installer may be prompted to choose one of these printer drivers at installation time, where the capabilities can be interrogated to provide meaningful information to display to the installer on a selection panel. As an example of the latter, suppose Product A is being installed, and that Product A requires installation of Function X. The installation package may contain software for Product B and Product C, each of which provides Function X. Capabilities are preferably used to specify the functions provided by Product B and Product C (and Dependencies class 560, discussed below, is preferably used to specify the functions required by Product A). The installation engine can then use this information to ensure that either Product B or Product C will be installed along with Product A.

As disclosed in the related inventions, ProductDescription class 530 is preferably designed as a container for various types of product information. Examples of this product information include the software vendor, application name, and software version of the software component. Instances of this class are preferably operating-system specific. The locations of icons, sound and video files, and other media files to be used by the product (during the installation process, and/or at run-time) may be specified in instances of ProductDescription. For licensed software, instances of this class may include licensing information such as the licensing terms and the procedures to be followed for registering the license holder. When an installation package provides support for multiple natural languages, instances of ProductDescription may be used to externalize the translatable product content (that is, the translatable information used during the installation and/or at run-time). This information is preferably stored in a resource bundle (or other type of external file or document, referred to herein as a resource bundle for ease of reference) rather than in an object instance, and will be read from the resource bundle on an on-demand basis.

The InstallFileSets class 540 is used in preferred embodiments of the object model disclosed in the related inventions as a container for information that relates to the media image of a software component. Instances of this class are preferably used to specify the manifest for a particular component. Tens or even hundreds of file names may be included in the manifest for installation of a complex software component. Resource bundles are preferably used, rather than storing the information directly in the object instance.

The related inventions disclose use of the VariableModel class 550 as a container for attributes of variables used by the component being installed. For example, if a user identifier or password must be provided during the installation process, the syntactical requirements of that information (such as a default value, if appropriate; a minimum and maximum length; a specification of invalid characters or character strings; etc.) may be defined for the installation engine using an instance of VariableModel class. In addition, custom or product-specific validation methods may be used to perform more detailed syntactical and semantic checks on values that are supplied (for example, by the installer) during the installation process. As disclosed for preferred embodiments of the related inventions, this validation support may be provided by defining a CustomValidator abstract class as a subclass of VariableModel, where CustomValidator then has subclasses for particular types of installation variables. Examples of subclasses that may be useful include StringVariableModel, for use with strings; BooleanVariableModel, for use with Boolean input values; PasswordVariableModel, for handling particular password entry requirements; and so forth. Preferably, instances of these classes use a resource bundle that specifies the information (including labels, tooltip information, etc.) to be used on the user interface panel with which the installer will enter a value or values for the variable information.

Dependencies class 560 is used to specify prerequisites and co-requisites for the installation package, as disclosed in the related inventions. Information specified as instances of this class, along with instances of the Capabilities class 520, is used at install time to ensure that the proper software components or functions are available when the installation completes successfully.

The related inventions disclose providing a Conflicts class 570 as a mechanism to prevent conflicting software components from being installed on a target device. For example, an instance of Conflicts class for Product A may specify that Product Q conflicts with Product A. Thus, if Product A is being installed, the installation engine will determine whether Product Q is installed (or is selected to be installed), and generate an error if so.

VersionCheckerModel class 580 is provided to enable checking whether the versions of software components are proper, as disclosed in the related inventions. For example, a software component to be installed may require a particular version of another component.

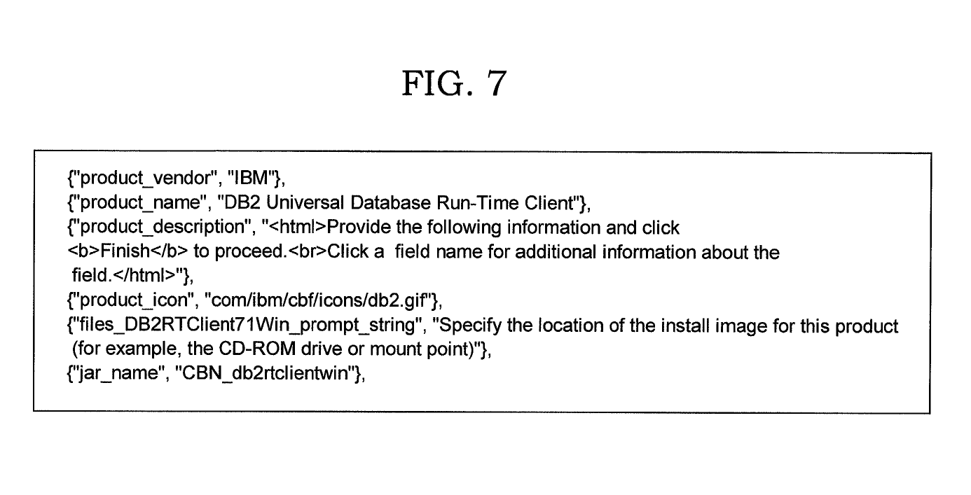

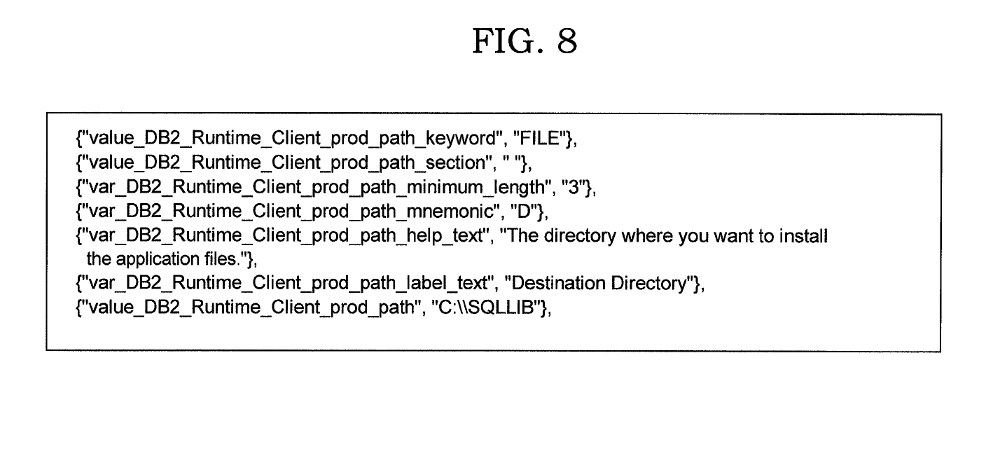

Preferably, the resource bundles referenced by the software components of the present invention are structured as product resource bundles and variable resource bundles. Examples of the information that may be specified in product resource bundles (comprising values to be used by instances of CommandLineModel 510, etc.) and in variable resource bundles (with values to be used by instances of VariableModel 550, ProductDescription 530, etc.) are depicted in FIGS. 7 and 8, respectively. (Note that while 2 resource bundles are shown for the preferred embodiment, this is for purposes of illustration only. The information in the bundles may be organized in many different ways, including use of a separate bundle for each class. When information contained in the bundles is to be translated into multiple natural languages, however, it may be preferable to limit the number of such bundles.)

Referring now to FIG. 6, an object model as disclosed in the related inventions for representing an installation suite comprising all the components present in a particular installation package, and enhancements thereto which may be made for the topological suites of the topology suite invention, will now be described. A Suite 600 object class serves as a container of 1 5 containers, with each instance containing a number of suite-level specifications in subclasses shown generally at 610 through 680. Each suite object also contains one or more instances of ProductModel 500 class, one instance for each software component in the suite. The Suite class may be used to enforce consistency among software components (by handling the inter-component prerequisites and co-requisites), and to enable sharing of configuration variables 20 among components. According to the topology suite invention, Suite class also contains information about target topologies (see Topologies class 680) which have been specified for the suite. The present invention dynamically selects from among these pre-specified topologies to provide an optimal configuration of the installation suite for the target environment into which the suite is being installed.

SuiteDescription class 610 is defined in the related inventions as a descriptive object which may be used as a key when multiple suites are available for installation. Instances of SuiteDescription preferably contain all of the information about a suite that will be made available to the installer. These instances may also provide features to customize the user interface, such as build boards, sound files, and splash screens.

As disclosed in the related inventions, ProductCapabilities class 620 provides similar information as Capabilities class 520, and may be used to indicate required or provided capabilities of the installation suite.

ProductCategory class 630 is defined in the related inventions for organizing software components (e.g. by function, by marketing sector, etc.). Instances of ProductCategory are preferably descriptive, rather than functional, and are used to organize the display of information to an installer in a meaningful way. A component may belong to multiple categories at once (in the same or different installation suites).

As disclosed in the related inventions, instances of ProductGroup class 640 are preferably used to bundle software components together for installation. Like an instance of ProductCategory 630, an instance of ProductGroup groups products; unlike an instance of ProductCategory, it then forces the selection (that is, the retrieval and assembly from the directory) of all software components at installation time when one of the components in the group (or an icon representing the group) is selected. The components in a group are selected when the suite is defined, to ensure their consistency as an installation group. In the example scenario of deploying a business-to-business solution including various middleware products, the defined groups may include one or more server groups and one or more client groups, as stated earlier.

Instances of VariableModel class 650 provide similar information as VariableModel class 550, as discussed in the related inventions, and may be used to specify attributes of variables which pertain to the installation suite.

VariablePresentation class 660 is used, according to the related inventions, to control the user interface displayed to the installer when configuring or customizing an installation package. One instance of this class is preferably associated with each instance of VariableModel class 650. The rules in the VariableModel instance are used to validate the input responses, and these validated responses are then transmitted to each of the listening instances of VariableLinkage class 670.

As disclosed in the related inventions, instances of VariableLinkage class 670 hold values used by instances of VariableModel class 650, thereby enabling sharing of data values. VariableLinkage instances also preferably know how to translate information from a particular VariableModel such that it meets the requirements of a particular ProductModel 500 instance.

According to the topology suite invention, instances of Topologies class 680 specify a predefined topology, the contents of which are preferably defined when the installation suite is being created, as has been discussed. If additional information about the target run-time environment or other suite customization input may be provided by the software installer, then instances of Topologies class may be associated with a template into which run-time information can be specified by the installer, such as the sample template 400 shown in FIG. 4.

Each instance of ProductModel class 500 in a suite is preferably independently se-rializable, as discussed in the related inventions, and is merged with other serialied instances comprising an instance of Suite 600.

During the customization process, an installer may select a number of physical devices or machines on which software is to be installed from a particular installation package. Furthermore, he may select to install individual ones of the software components provided in the package. This is facilitated by defining a high-level object class (not shown in FIGS. 5 or 6) which is referred to herein as “Groups”, which is a container for one or more Group objects. A Group object may contain a number of Machine objects and a number of ProductModel objects (where the ProductModel objects describe the software to be installed on those machines, according to the description of FIGS. 5 and 6). Machine objects preferably contain information for each physical machine on which the software is to be installed, such as the machine's Internet Protocol (IP) address and optionally information (such as text for an icon label) that may be used to identify this machine on a user interface panel when displaying the installation package information to the installer.

When using JavaBeans of the Java programming language to implement installation objects according to the installation object model, the object attributes and methods to be used for installing a software package are preferably specified as properties and methods of the JavaBeans. A JavaBean is preferably created for each software component to be included in a particular software installation package, as well as another JavaBean for the overall installation suite. When using Object REXX, the object attributes and methods to be used for installing a software package are preferably specified as properties and methods in Object REXX. When using structured documents, the object attributes and methods are preferably specified as elements in the structured documents. (Refer to the related inventions for a detailed discussion of these approaches.)

The process of customizing a software installation package for use in a particular target environment, building the component (i.e. ProductModel) objects and Suite object, and then performing the installation according to the present invention will now be described with reference to the flowcharts in FIGS. 9 through 12. (These processes may be performed in succession during one invocation of the installation engine of the present invention, or may be separated in time by invoking individual ones of these functions in the installation engine.) It should be noted that the related inventions have disclosed a general software installation process using the model and framework of their respective FIGS. 5 and 6, and preferred embodiments of logic which may be used to implement this installation process have been described therein with reference to their respective flowcharts which correspond to FIGS. 9 through 12. The discussion of the logic underlying the installation process in FIGS. 9 through 12 is repeated herein to establish a context for describing the present invention. Alterations to this processing to support the present invention are also described within the overall context of these figures.

A software installer invokes the installation engine (Block 900), and then selects a particular software suite to be customized (Block 905). According to the present invention, topology information describing the installer's run-time environment is then obtained (Block 910). As stated earlier, this information is preferably obtained using prior art inventory discovery techniques. As has also been stated, the discovery process may have been executed prior to invoking the installation engine in FIG. 9, if desired, in which case Block 910 preferably obtains this previously-stored information; or, the inventory process may be initiated at the present time.

As shown at Block 915, the obtained topology information is used as input to a rules engine (which is preferably a general-purpose comnmercially-available rules engine of the prior art). The output of the rules engine is an identification of a particular configuration, which has been specified in the action part of a rule that matches when analyzing the rules engine input. This output is used in Block 920 to automatically select an appropriate one of the topology objects 680, according to the present invention. Preferably, this selection comprises using the rules engine output to locate an instance of Topology class 680 which has a corresponding name or identifier.

The Suite bean corresponding to the installation suite selected at Block 905 is retrieved from the directory and deserialized (Block 925), as required, creating a Suite object (Block 930). A bean corresponding to the automatically-selected topology is also retrieved and deserialized, if stored independently, creating a Topologies object. Using information previously stored in the Suite object, a user interface is generated (Block 935). One or more ProductModel beans which comprise the Suite bean may also be retrieved and deserialized at this time, if they are stored independently, and information from the resulting ProductModel objects and/or Topologies object may be used when generating the user interface. For example, a generated user interface may present a name and descriptive information about the suite (using the SuiteDescription 610 instance), and a name and descriptive information for each component in the suite (using ProductDescription 530 instances). Similarly, the generated user interface (or, alternatively, a topology-specific user interface display or template) may optionally present information about the selected topology and may request entry of data values for customizing this topology, if the installer is to manually provide additional customization input. (Refer to the discussion of FIG. 4, above, regarding a sample topology-specific display.)

The generated user interface is then displayed (Block 940) to the installer. Customization values are then accepted from the installer (Block 945), if appropriate. At Block 950, the input data is validated using the methods specified in instances of a CustomValidator abstract class. (Refer to the discussion of VariableModel class 550, above, for more information on CustomValidator.) An iterative approach is preferably used for accepting and validating the input data.

If execution of the rules engine results in more than one Topology object being selected, for example when the suite creator has defined the rules and Topology objects in such a manner that an installation suite uses a set of Topology object instances, the processing of Block 910 may be repeated after obtaining and validating the input data for each selected topology. (This may happen, for example, in scenarios where it is preferable to separately select the software components to be installed on servers and the software components to be installed on client devices.) If the rules engine in use is designed to stop evaluating rules upon detecting a match, then multiple instances of Topology class may be located either by specifying multiple topology object identifiers in the action part of the rules, or the rules engine may be invoked multiple times for this purpose.

When the data entry and validation is complete, control reaches Block 955, where the installer is allowed to define groups of target machines, and to select particular software components from the suite that are to be associated with an installation to that group of machines. This information is then stored in a Group object at Block 960. If the customized suite is not to be built or installed at this time, the object is preferably serialized (not shown in FIG. 9). The Groups object, which is a container for one or more Group objects, is preferably serialized in an initialization file (having the suffix “.ini”). Thus, customization of software and information to be presented on the user interface panel to the installer is preserved in a text file for later use during the installation process.

Note that while FIG. 9 describes customizing an installation package for an entire suite, an installer may also be allowed to individually customize the objects or components of the suite, and may also be allowed to individually customize portions of a selected topology which are not automatically customized by execution of the rules with the rules engine. Based on the description of FIG. 9, it will be obvious to one of ordinary skill in the art how this logic may be structured.

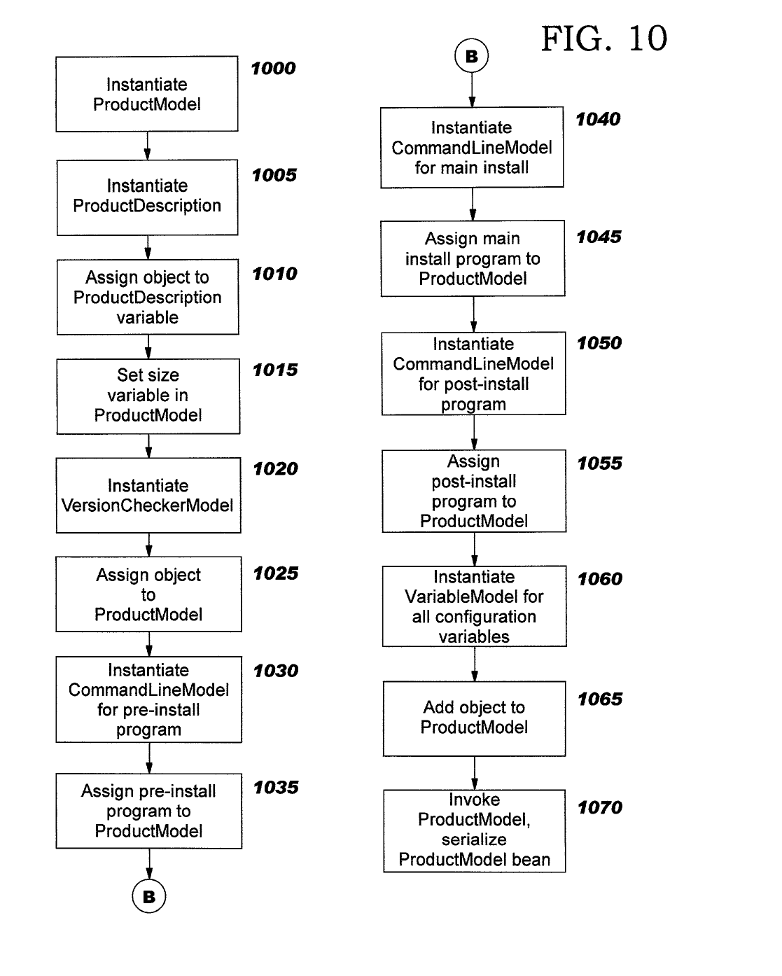

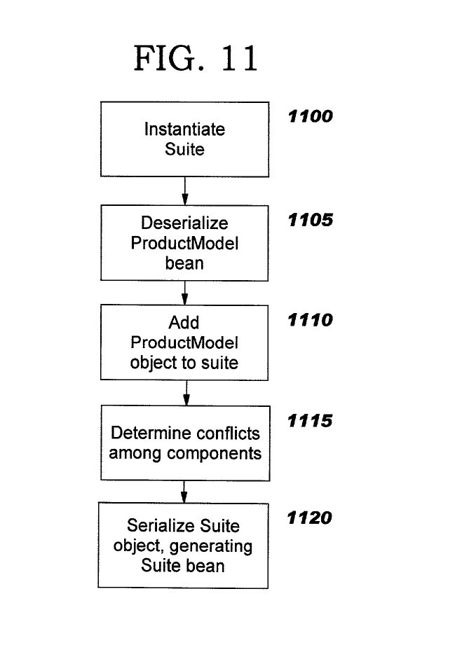

When the installer is ready to build an installation package reflecting the customized information, a build process is performed to assemble the objects for each ProductModel object and then for the Suite object. These processes are illustrated in FIGS. 10 and 11, respectively.

The build process for a ProductModel bean begins at Block 1000, where ProductModel 500 is instantiated. At Block 1005, ProductDescription is then instantiated, and the resulting object is assigned (Block 1010) to a ProductDescription variable of the ProductModel object.

It should be noted that in an object-based embodiment of the present invention, the instantiations described with reference to FIG. 10 are preferably instantiations only of classes, and that internal variables are not being directly set. This is because, in preferred embodiments, the classes ProductDescription, VersionCheckerModel, CommandLineModel, and VariableModel get their variable information from a resource bundle rather than through variable settings within an object. In a structured document-based embodiment, the discussions of instantiations preferably represent parsing of documents that hold the values of properties or attributes of these elements.

Next, a size variable of ProductModel is set to the installed size of this software component (Block 1015). VersionCheckerModel is then instantiated (Block 1020), and the resulting object is assigned (Block 1025) to ProductModel. Preferably, this assignment comprises issuing a “setVersionChecker (VersionCheckerModel)” call (or a call having similar syntax).

Block 1030 instantiates CommandLineModel 510, or one of its subclasses for a particular installation environment (as discussed above), for the pre-install program and assigns the resulting object to ProductModel at Block 1035. This assignment preferably comprises issuing a call having syntax such as “setPreInstall (CommandLineModel)”. In preferred embodiments, custom programs may be invoked to perform integration of a suite in its target environment, and/or integration of individual ones of the components. The particular custom programs to be invoked are thus defined using instances of CommandLineModel, in the same manner that a CommandLineModel instance defines how to invoke the installation of each particular component. Issuing the “setPreInstall” call establishes the custom program that is to be executed prior to installing this component (and may be omitted when there is no such program). Another instance of CommandLineModel (or a subclass) is then instantiated and assigned to ProductModel to specify invocation information for installation of the component itself (Blocks 1040 and 1045). The assignment may be performed using call syntax such as “setInstall (CommandLineModel)”. If a custom post-installation integration program is to be executed, Blocks 1050 and 1055 instantiate the proper object and assign it to ProductModel using a call with syntax such as “setPostlnstall (CommandLineModel)”.

For each configuration variable of this component, a subclass of VariableModel is instantiated (Block 1060) and added to ProductModel (Block 1065). Finally, an invocation of ProductModel is performed (Block 1070), which generates a serialized output ProductModel bean.

The build process for a Suite bean begins at Block 1100 of FIG. 11, where Suite 600 is instantiated. For each component in the suite, the ProductModel bean is deserialized (Block 1105) and the resulting ProductModel object is added (Block 1110) to a vector of suite products. Block 1115 determines whether any of the products in the suite conflict with one another, using the information stored in each Conflicts class 570. Assuming that all conflicts are resolved, Block 1120 serializes the Suite object to generate an output Suite bean.

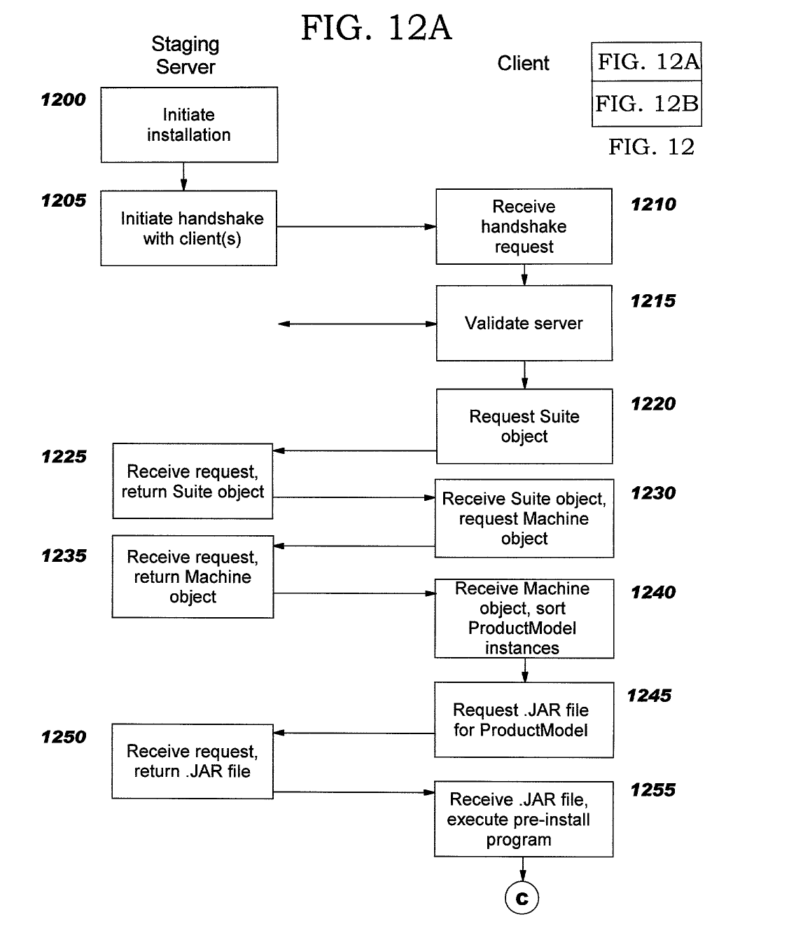

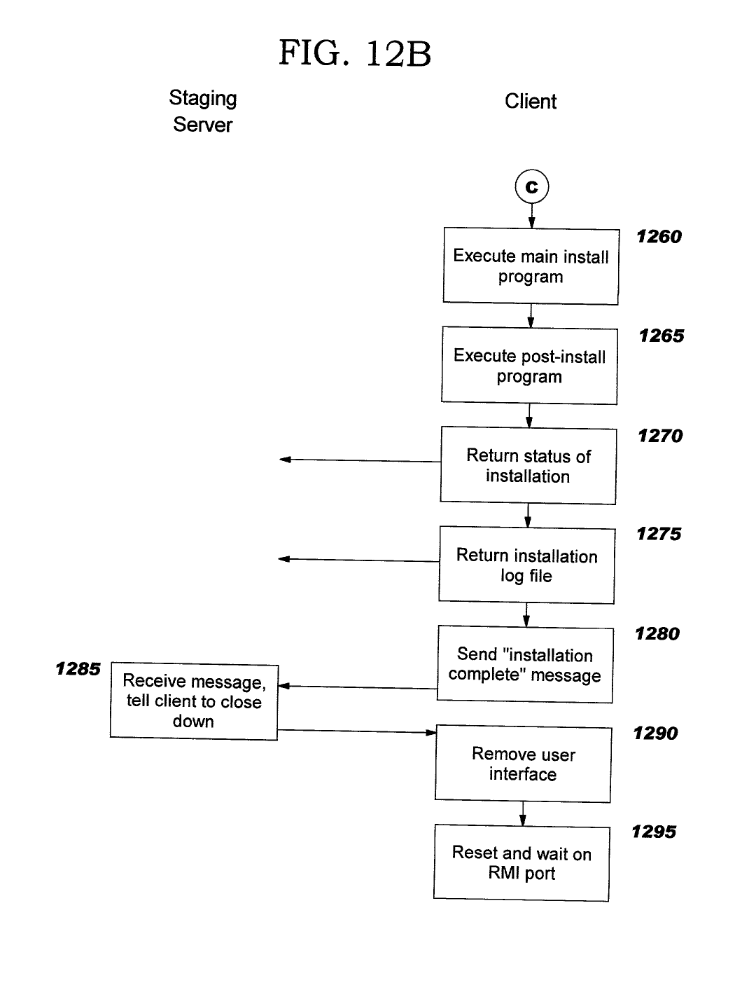

FIG. 12 depicts a preferred embodiment of logic with which the installation time processing may be performed. This processing is described in terms of installation from a staging server on which the suite beans and component beans, as well as their objects, are stored (or are otherwise accessible), across a network to one or more target devices. It will obvious to one of ordinary skill in the art how the process of FIG. 12 may be altered for use in other installation scenarios, including installation on a stand-alone machine which is not connected to a network, or a local installaion where the client and server are co-resident, or installation using a client/server “pull” model rather than the “push” model illustrated in FIG. 12. (Note that the staging server may optionally be a directory server, and the techniques of the related invention entitled “Object Model and Framework for Installation of Software Packages using a Distributed Directory” may also be embodied within an implementation of the present invention. Refer to this related patent for more information on suite installation using a directory server.)

The installation process of FIG. 12 begins with an installer initiating the installation process (Block 1200), for example by selecting a suite from a user interface display. (In optional aspects of the present invention, the installer may be prompted to confirm that he wishes to install the automatically-selected topology for the installation suite.) The staging server then preferably initiates a handshaking protocol with each target device (Block 1205), where those target devices were preferably identified in the automatically-obtained customization information for the selected topology. Referring again to the example scenario, if the selected topology includes WebSphere software for a Linux server, DB2 server software for several AIX servers, and client software for a number of Windows clients, then the network addresses of these target devices may have been automatically obtained from the inventory discovery process. Or, alternatively, the network addresses may have been obtained via another technique (such as by having the software installer provide input using a template such as that shown in FIG. 4). These network addresses are used by the staging server to contact each of the devices: the staging server installation scenario of FIG. 12 requires each target machine to have “listener” software installed, where this software is adapted to receiving these installation notifications from the staging server,

At Block 1210, the listener software on a client (target) device receives the handshaking request sent by the stating server. An authentication process is then preferably performed (Block 1215), to ensure that software is being downloaded from a trusted source. In preferred embodiments, this authentication process comprises sending a challenge to the staging server, which the staging server will then sign using the private key of a previously-created public/private key pair. When this signed challenge is received by the client device, the client validates the signature using the staging server's public key. (Techniques for performing authentication using signed messages in this manner are well known in the art, and will not be described further herein.)

If the authentication is successful, each target client then requests the staging server to send the necessary objects to perform the software installation on that device. In particular, the device requests delivery of a suite object (Block 1220), where the suite object will contain one or more component objects for installation on this client device, according to a topology which has been defined by the suite creator and for which the topological installation suite has been adapted by the presence of a Topology object created according to the topology suite invention. The staging server receives this request, and returns the appropriate Suite object (Block 1225). Upon receiving the Suite object, the client may then request (Block 1230) delivery of a Machine object. A Machine object contains one or more component objects which are appropriate to this particular type of client device, as previously described. After receiving this request, the staging server returns the requested object (Block 1235).

When the requested object is received, the client preferably sorts the component objects according to a priority value that may be specified in ProductModel, and/or dependencies on other components (Block 1240). Block 1245 then begins an iterative process that extends through Block 1275, and which is performed for each component that is to be installed. At Block 1245, the client sends a request to the staging server for the jar (i.e. the Java Archive, or serialized ProductModel) file for this component. The server receives this request (Block 1250), and returns the corresponding jar file.

Upon receiving the jar file, the client executes the pre-install program (Block 1255), if one has been defined. Block 1260 then executes the installation of the component itself, and Block 1265 executes the post-install program, if one has been defined for this component. (Refer to the description of Blocks 1030 through 1055, above, for more information on pre- and post-install programs.)

The status of the component installation is returned to the staging server (Block 1270). If a log file was defined for this purpose, as previously described, the log file is also preferably returned (Block 1275).

When all components have been installed, control reaches Block 1280. The client preferably sends a “Suite installation complete” message to the staging server. Upon receiving this message, the staging server issues a message to the client (Block 1285), telling it to close down the installation process. The client, upon receiving this message, performs termination logic such as removing the installation user interface (Block 1290). The client then resets and waits on its RMI port (Block 1295). (In preferred embodiments, HTTP message exchanges are used for transferring relatively large amounts of data, RMI is used for lightweight message exchange.) The installation processing then ends.

As has been demonstrated, the present invention defines an improved installation process using an object model and framework that provides a standard, consistent approach to software installation across many variable factors such as product and vendor boundaries, computing environment platforms, and the language of the underlying code as well as the preferred natural language of the installer. Use of the techniques disclosed herein enables more efficient and flexible software installation than is available in the prior art, by automatically and dynamically adapting the installation process for a particular topology of a destination run-time environment, as has been described. Using the disclosed techniques, the teachings of the topology suite invention are extended into an active run-time rules-based suite. The software installation process can be adapted and configured dynamically based on the unique topology of the environment in which the suite is being installed, yet the burden on the software installer to understand the intricacies of his run-time environment (and to reflect those details in the suite customization process) is greatly reduced.

Note that while preferred embodiments are described herein as using a “rules engine”, this is not meant to imply that use of a complex software product is required. In some cases, the process of matching run-time environment information to predefined target values may be relatively simple. For example, a script or other simple program may be created to evaluate input values against patterns, or perhaps to evaluate input values against programming language statements (such as “IF-THEN”-type statements) which embody conditions and actions having semantics of the type which have been described herein as being embodied in rules. These alternative types of matching processes may be substituted for a commercially-available rules engine without deviating from the scope of the present invention, and the term “rules engine” as used herein is intended to encompass such other matching processes.

Note that the novel techniques of one or more of the related inventions may also be included in an embodiment of the present invention. By review of the teachings of those related inventions, it will be obvious to one of skill in the art how those teachings may be integrated with the novel techniques of the present invention.

While preferred embodiments of the present invention have been described, additional variations and modifications in that embodiment may occur to those skilled in the art once they learn of the basic inventive concepts. Therefore, it is intended that the appended claims shall be construed to include preferred embodiments as well as all such variations and modifications as fall within the spirit and scope of the invention.

What is claimed is:

1. A method of improving installation of software packages, comprising steps of
defining an object model representing a plurality of components of a software installation package and one or more topology objects, wherein each component comprises a plurality of objects and wherein each topology object identifies one or more selected ones of the components;
populating the object model to describe a particular software installation package and one or more topologies for deployment of that particular software installation package; and
defining one or more rules for execution by a rules engine, wherein each rule specifies one or more conditions and at least one action to be taken when the specified conditions are matched during the execution by the rules engine, and wherein the specified conditions pertain to a target run-time environment and the at least one action may be used to select from among the topologies.

2. The method according to claim 1, further comprising the step of instantiating a plurality of objects according to the defined object model, and wherein the populating step populates the instantiated objects.

3. The method according to claim 2, wherein the instantiated objects are JavaBeans.

4. The method according to claim 2, wherein the instantiating step instantiates an object for the particular software installation package and one or more component objects for each software component included in the particular software installation package.

5. The method according to claim 1, further comprising the steps of
dynamically discovering information pertaining to the target run-time environment;
using the dynamically discovered information as input to the execution by the rules engine, wherein the execution results in matching a selected one of the rules;
automatically selecting, based upon the at least one action in the matching rule, at least one of the topologies for deployment; and
using the populated object model to install the particular software installation package using the selected topology.

6. The method according to claim 5, wherein the step of using the populated object model further comprises the steps of
identifying one or more target machines on which the particular software installation package is to be installed;
downloading the particular software installation package to the identified target machines; and
performing an installation at each of the identified target machines using the downloaded particular software installation package.

7. The method according to claim 6, further comprising the step of authenticating a server on which the downloading step operates prior to an operation of the step of performing the installation.

8. The method according to claim 5, wherein the step of using the dynamically discovered information as input to the execution by the rules engine also serves to configure one or more values needed by the selected topology.

9. A system for improving installation of software packages, comprising:
means for defining an object model representing a plurality of components of a software installation package and one or more topology objects, wherein each component comprises a plurality of objects and wherein each topology object identifies one or more selected ones of the components;
means for populating the object model to describe a particular software installation package and one or more topologies for deployment of that particular software installation package; and
means for defining one or more rules for execution by a rules engine, wherein each rule specifies one or more conditions and at least one action to be taken when the specified conditions are matched during the execution by the rules engine, and wherein the specified conditions pertain to a target run-time environment and the at least one action may be used to select from among the topologies.

10. The system according to claim 9, further comprising:
means for dynamically discovering information pertaining to the target run-time environment,
means for using the dynamically discovered information as input to the execution by the rules engine, wherein the execution results in matching a selected one of the rules;
means for automatically selecting, based upon the at least one action in the matching rule, at least one of the topologies for deployment; and
means for using the populated object model to install the particular software installation package using the selected topology.

11. The system according to claim 10, wherein the means for using the populated object model further comprises:
means for identifying one or more target machines on which the particular software installation package is to be installed;
means for downloading the particular software installation package to the identified target machines; and
means for performing an installation at each of the identified target machines using the downloaded particular software installation package.

12. The system according to claim 10, wherein the means for using the dynamically discovered information as input to the execution by the rules engine also serves to configure one or more values needed by the selected topology.

13. A computer program product for improving installation of software packages, the computer program product embodied on one or more computer-readable media and comprising:
computer-readable program code means for defining an object model representing a plurality of components of a software installation package and one or more topology objects, wherein each component comprises a plurality of objects and wherein each topology object identifies one or more selected ones of the components;
computer-readable program code means for populating the object model to describe a particular software installation package and one or more topologies for deployment of that particular software installation package; and
computer-readable program code means for defining one or more rules for execution by a rules engine, wherein each rule specifies one or more conditions and at least one action to be taken when the specified conditions are matched during the execution by the rules engine, and wherein the specified conditions pertain to a target run-time environment and the at least one action may be used to select from among the topologies.

14. The computer program product according to claim 13, further comprising:
computer-readable program code means for dynamically discovering information pertaining to the target run-time environment;
computer-readable program code means for using the dynamically discovered information as input to the execution by the rules engine, wherein the execution results in matching a selected one of the rules;
computer-readable program code means for automatically selecting, based upon the at least one action in the matching rule, at least one of the topologies for deployment; and
computer-readable program code means for using the populated object model to install the particular software installation package using the selected topology.

15. The computer program product according to claim 14, wherein the computer-readable program code means for using the populated object model further comprises:
computer-readable program code means for identifying one or more target machines on which the particular software installation package is to be installed;
computer-readable program code means for downloading the particular software installation package to the identified target machines; and
computer-readable program code means for performing an installation at each of the identified target machines using the downloaded particular software installation package.

16. The computer program product according to claim 14, wherein the computer-readable program code means for using the dynamically discovered information as input to the execution by the rules engine also serves to configure one or more values needed by the selected topology.
